(19) United States
(12) Patent Application Publication
(10) Pub. No.: US 2009/0022342 A1
(43) Pub. Date: Jan. 22, 2009

(54) DIGITAL DECODER BOX WITH MULTI-CHANNEL AUDIO SOURCE FORMAT INDENTIFICATION FUNCTION

(75) Inventor: Bill Yang, Taipei City (TW)

Correspondence Address: J C PATENTS, INC., 4 VENTURE, SUITE 250, IRVINE, CA, 92618, US

(73) Assignee: Cotron Corporation, Taipei City (TW)

(21) Appl. No.: 12/237,585

(22) Filed: Sep. 25, 2008

Related U.S. Application Data
(63) Continuation-in-part of application No. 11/760,794, filed on Jun. 11, 2007.

(30) Foreign Application Priority Data
Apr. 4, 2007 (TW) 96205490
Jul. 3, 2008 (TW) 97211844

(51) Int. Cl. H04R 5/033

(52) U.S. Cl. 381/307

(57) ABSTRACT

A digital decoder box is introduced for processing multiple-channel digital audio sources. The digital decoder box can detect formats of audio sources and perform different decoding processes, and output the audio sources to an earphone with 5.1 channel speakers. When a 5.1 channel audio source is received, the digital decoder box decodes the audio source and outputs the audio source to the 5.1-channel earphone. Three sets of audio signals are outputs including front stereo signals, rear stereo signals, center channel signal, and sub woofer signal. When a two channel audio source is received, the amplified audio signals from the digital decoder box are output to at least two sets of speakers within the 5.1-channel earphone. By the various speaker combinations within the 5.1-channel earphone, sound effects of separated sound fields may be generated. A two channel stereo audio source may then have different sound effects.

### CROSS-REFERENCE TO RELATED APPLICATION

This application is a continuation-in-part of a prior application Ser. No. 11/760,794, filed on Jun. 11, 2007, which claims the priority benefit of Taiwan application serial no. 96205490, filed on Apr. 4, 2007. The present application claims the priority of Taiwan serial no. 97211844, filed on Jul. 3, 2008. The entirety of each of the above-mentioned patent applications is hereby incorporated by reference herein and made a part of this specification.

### BACKGROUND OF THE INVENTION

1. Field of Invention

The present invention relates to a digital decoder box for a multi-channel earphone and more particularly, to a digital decoder box for an earphone with a multi-channel stereo sound field.

2. Description of Related Art

With the development of digital technologies, people's entertainment also becomes more and more digitalized. For example, the Digital Versatile Disc (DVD) player has become a common household video player. The DVD player is typically equipped with the decoding function for the Dolby Digital System or Digital Theater System (DTS) to decode digital signals and output analog signals to multi-channel amplifiers to enable the 5.1-channel speakers to generate sound.

Multi-channel amplifiers and speakers are indispensable for high quality digital entertainment. The 5.1-channel speaker is the most basic multi-channel speaker.

In general, in a home theater system with the 5.1-channel amplifier and speaker, the amplifier amplifies different audio signals and outputs the audio signals to the left and right speakers of the front main channel, the center channel speaker, and the left and right speakers of the surround or rear channel, and the sub woofer speaker so as to generate a three-dimensional sound effect for people to feel as if in a realistic situation.

However, playing sounds with speakers is inappropriate in circumstances where that may disturb others. In this case, an earphone is more suitable for listening. A conventional earphone is equipped with a speaker on the left and a speaker on the right. Thus, a user is not able to enjoy the multi-channel sound effects generated from a DVD player. For the reason, the conventional technology provides an earphone with a plurality of speakers, respectively disposed on the left and the right and including front main channel speakers, center channel speakers, surround channel speakers, and sub woofer speakers which may be connected to an audio source with multi-channel outputs. However, the current amplifier that provides audio source signals to the multi-channel earphone does not identify and thereby perform different decoding processes for digital audio source signals of different formats.

### SUMMARY OF THE INVENTION

The present invention provides a digital decoder box suitable for connecting to a multi-channel earphone. The digital decoder box includes a digital signal processor, a multi-channel digital to analog converter, a multi-channel earphone amplifier, an input format detector, a delay circuit, and a sub/front speaker select switch. The digital signal processor is used to receive a digital audio source signal and output a decoded signal after the decoding process. The multi-channel digital to analog converter is connected to the digital signal processor to receive the decoded signal and convert the decoded signal to an analog signal. The multi-channel earphone amplifier is connected to the multi-channel digital to analog converter to receive the analog signal, amplify the analog signal, and output front channel signals (including a left signal and a right signal), surround channel signals (including a left signal and a right signal), a center channel signal, and a sub woofer signal. The input format detector is connected to the multi-channel digital to analog converter to detect the actual number of output channels of the decoded signal and output a control signal to switch the operation mode of the earphone accordingly. The sub/front speaker select switch is connected to the input format detector and the delay circuit to receive a front channel signal output from the delay circuit and a sub woofer signal from a 6-channel earphone amplifier and switch between the front channel signal and the sub woofer signal according to the control signal. When only the front channel has an output but both the surround channel and sub woofer channel have no output, the sub/front speaker select switch immediately turns off the output for the sub woofer channel and outputs the left and right front channel output to the left and right sub woofer speakers respectively, to enhance the stereo sound effects. The delay circuit is used to receive all channel signals, perform a delay process, and then output the signals to the earphone to prevent damage to the user's eardrums due to the impact sound when the earphone is turned on.

The above mentioned digital decoder box further includes an auto input selector to receive two different audio sources, choose one of the audio sources to be the audio source signal, and output the chosen audio source signal to the digital signal processor.

The different audio sources are transmitted from an optical cable or a coaxial cable. The auto input selector processes the audio source from the optical cable with a higher priority over the audio source from the coaxial line.

In the above mentioned digital decoder box, the digital signal processor may decode encoded signals of Dolby Digital 5.1, Dolby Digital 2.0, Dolby Pro Logic, LPCM (stereo sound), or DTS formats.

The above mentioned digital decoder box further comprises a display module used to display the operating status of the digital decoder box. The operating status includes the decoding format of the digital decoder box and the volume settings of the different channels.

The above mentioned digital decoder box further comprises a control panel for the user to input values to adjust the control setup of the digital decoder box.

The above mentioned digital decoder box further comprises a microcontroller to control the operation modes of the digital signal processor and the multi-channel digital to analog converter. The operation modes include controlling the volume and monitoring the operation status of the digital signal processor.

The above mentioned multi-channel earphone includes a main body, which comprises a chamber body and a main chamber supporting bar, a main speaker and a first sub speaker, and at least a pair of chamber extension tubes. The main chamber supporting bar has a plurality of holes, wherein a front mixing chamber, a main chamber, and a rear chamber are formed in the chamber body. The main speaker is disposed on the main chamber supporting bar and the first sub speaker is disposed on a protrusion portion of the chamber body. The rear chamber is formed between the main chamber supporting bar and the main speaker and the first sub speaker. The pair of the chamber extension tubes is disposed outside the chamber body and respectively has an opening toward the interior of the chamber body to form a part of the main chamber. Through the space in the interior of the chamber body and the space of the chamber extension tubes, a composite sound field characteristic is formed by adjusting the front mixing chamber, the main chamber, and the rear chamber in the earphone structure and used as the output of the multi-channel earphone.

In order to the make the aforementioned and other objectives, features and advantages of the present invention more comprehensible, a preferred embodiment accompanied with figures is described in detail below.

### BRIEF DESCRIPTION OF THE DRAWINGS

FIG. 1 illustrates the digital decoder box capable of detecting audio source formats and the applications thereof according to a preferred embodiment of the present invention.

FIG. 2 shows the top view, the front view, the rear view, and the left view of the digital decoder box capable of detecting audio source formats according to an embodiment of the present invention.

FIGS. 3A-3D respectively illustrate a front side view, rear side view, a front view, and a rear view of the multi-channel earphone according to a preferred embodiment of the present invention.

FIG. 3E illustrates a schematic cross-sectional view and an exploded view of the multi-channel earphone shown in FIG. 3A.

FIG. 4 is a schematic diagram of the circuits of a digital decoder box capable of detecting audio source formats according to an embodiment of the present invention.

### DESCRIPTION OF EMBODIMENTS

The present invention provides a digital decoder box suitable for receiving multi-channel audio sources. The digital decoder box is capable of detecting the formats of the received audio sources, performing various decoding processes, and then, outputting the audio sources to a 5.1-channel earphone.

For example, when receiving an audio source with 5.1 channels output from a DVD player or a game player, the digital decoder box decodes the 5.1-channel audio source and outputs the audio source to the 5.1-channel earphone for playing. The output signal includes three sets of signal sources, for example, a front stereo signal, a rear stereo signal, and a center channel signal and a sub woofer signal.

However, if the received audio source is a two-channel stereo audio source such as a two-channel audio source provided by a DVD player or an audio source of a linear pulse code modulation (LPCM) format, the digital decoder box of the present invention outputs the amplified signal simultaneously to at least two sets of speakers in the 5.1-channel earphone for playing. By using different combinations of the speakers in the 5.1-channel earphone, separated sound field effects may be generated. Accordingly, the originally two-channel stereo audio source may have different sound field effects.

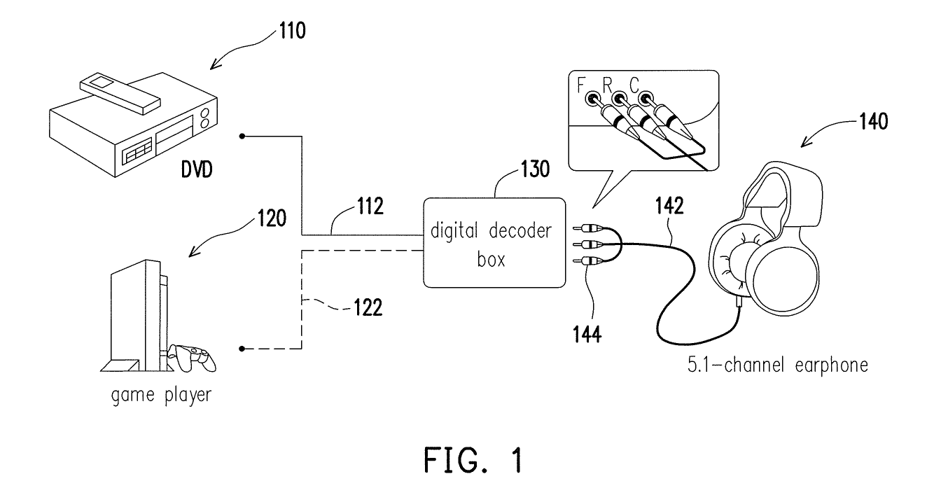

Referring to FIG. 1, FIG. 1 illustrates a digital decoder box capable of detecting audio source formats and the applications thereof according to a preferred embodiment of the present invention. A digital decoder box 130 of the present embodiment may be connected to a Digital Versatile Disc (DVD) player 110 through a line 112 which may be a signal line of any format, for example, an optical cable, a coaxial cable, or others. In addition, the digital decoder box 130 of the present embodiment may be connected to a game console 120 through various types of wires. The output of the digital decoder box 130 is connected to a 5.1-channel earphone 140 through 3.5 mm phone jacks as shown in the figure with a connection port 144 having three connection terminals.

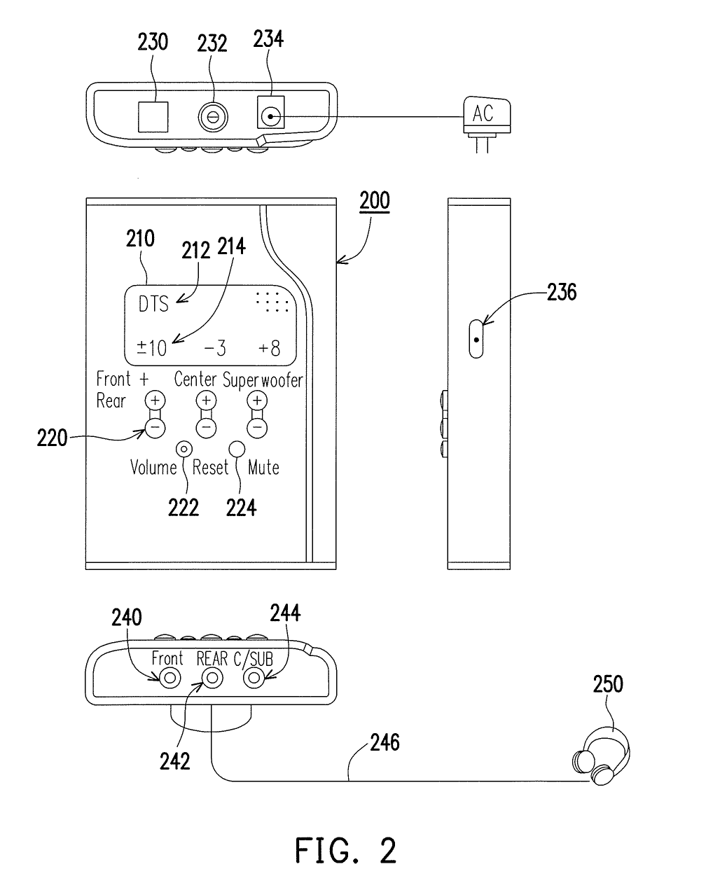

Referring to FIG. 2, FIG. 2 shows the top view, the front view, the rear view, and the left view of a digital decoder box 200 capable of detecting audio source formats according to an embodiment of the present invention. The digital decoder box 200 is capable of detecting the format of an audio source and displaying the format on a display screen 210. For example, if the display screen 210 shows “DTS,” the audio source is a DTS multi-channel audio source and if the audio source is of Dolby Digital format, the display screen shows “Dolby.” In addition, if the audio source is a two-channel stereo audio source, the display screen may show “Stereo,” for example. If the audio source is an LPCM audio source, the display screen shows “LPCM.” The displayed types of formats depend on the formats of the audio sources received by the digital decoder box 200. The above mentioned types of formats are more common but the types of formats are not limited to the above herein.

The above mentioned DTS is the abbreviation of Digital Theater System which is one of the multi-channel audio formats commonly used in DVD sound effects with the most common format being the 5.1 channel. The above mentioned Dolby Digital format was developed by Dolby Laboratories, a American company, and is a well-known multimedia storage format. Dolby Digital or referred to as AC-3, is the most common version of independent 6-channel and the most well-known 5.1-channel technology.

The digital decoder box 200 further comprises volume adjusting buttons 220 for controlling output volumes including an up and a down buttons for controlling the front and surround speakers (as shown in the figure as “Front+Rear”), an up and a down buttons for controlling the center speaker (as shown in the figure as “Center”), and an up and a down buttons for controlling the sub woofer speaker (as shown in the figure as “Sub Woofer”) The display screen 210 also shows the current volume setup as illustrated by reference numeral 214 with numbers “+10,” “−3,” and “+8.” In addition, the digital decoder box 200 further comprises a button 222 for resetting the volume (as shown in the figure as “Volume Reset”) and a mute button 224 (as shown in the figure as “Mute”). The volume control of the digital decoder box 200 keeps the current volume settings for different channels in memory so the settings will not be lost when the power is turned off. However, when it is required to reset the settings, the user only needs to press the reset button 222.

The digital decoder box 200 has two input ports 230 and 232 on the side. The input port 230 is for optical cable and the input port 232 is coaxial cable. The digital decoder box 200 further comprises a power input port 234, which may be connected to an AC power source through an AC outlet (as shown in the figure as “AC”). The digital decoder box 200 has a power switch 236 on the other side to turn on or turn off the digital decoder box 200.

The digital decoder box 200 has three signal output ports 240, 242, and 244 on yet another side to connect to a multi-channel earphone 250 through a connection wire with 3.5 mm phone plugs, for example. The signal output ports 240, 242, and 244 respectively provide signals to the front channel (shown in the figure as “Front”), the surround channel (shown in the figure as “Rear”), and the center and sub woofer channel (shown in the figure as “C/Sub”).

If the digital decoder box 200 receives a 5.1-channel audio source from a DVD player or a game console, the digital decoder box decodes and amplifies the 5.1-channel audio source and then outputs the audio source to the 5.1-channel earphone. The output signals include three sets of analog signals, front stereo signal, rear stereo signal, and center and sub woofer signals, for example, provided to the multi-channel earphone 250 to generate multi-channel or surround sound effects.

If the digital decoder box 200 receives a two-channel stereo audio source such as Dolby 2.0 channel or an LPCM audio source from a music CD, the digital decoder box 200 decodes and amplifies the signals and then simultaneously outputs the signals to at least two sets of speakers in the 5.1-channel earphone for playing. For example, the digital decoder box simultaneously outputs the signals to the front speakers and sub woofer speakers of the multi-channel earphone through the signal output ports 240 and 244, which differs from the conventional method of merely outputting signals to the set of front speakers of the multi-channel earphone 250. As such, by using the space arrangement of different combinations of the speakers in the multi-channel earphone 250, separate sound field effects may be generated and a stereo audio source that is originally two-channel may generate different sound field effects.

The multi-channel earphone provided by the present invention enables a multi-channel earphone with extension chambers to have a full and solid sound field and a multi-channel surround sound effect while maintaining minimized dimensions. The earphone main body comprises a chamber body and a main chamber supporting bar or a partition plate in the chamber body. A front mixing chamber, a main chamber, and a rear chamber are formed in the chamber body. A main speaker is disposed on the main chamber supporting bar or partition plate. A sub speaker is disposed behind the chamber body and forms a rear chamber between the sub speaker itself and the main chamber supporting bar. Through the space in the interior of the chamber body, a composite sound field characteristic is formed by adjusting the front mixing chamber, the main chamber, and the rear chamber in the earphone structure and used as the output of the multi-channel earphone.

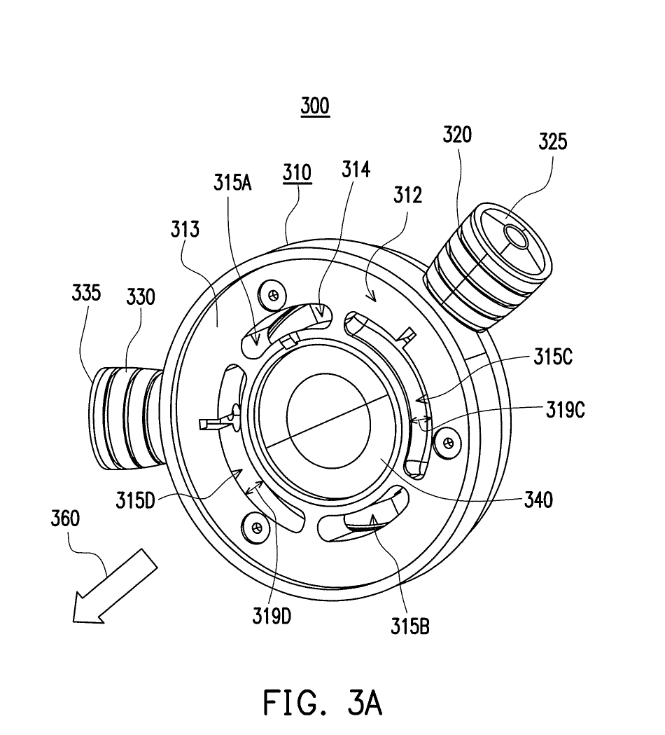

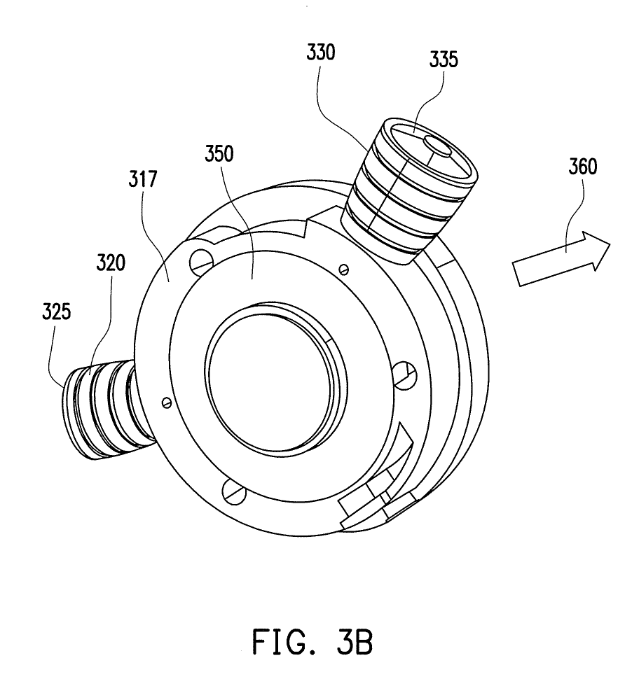

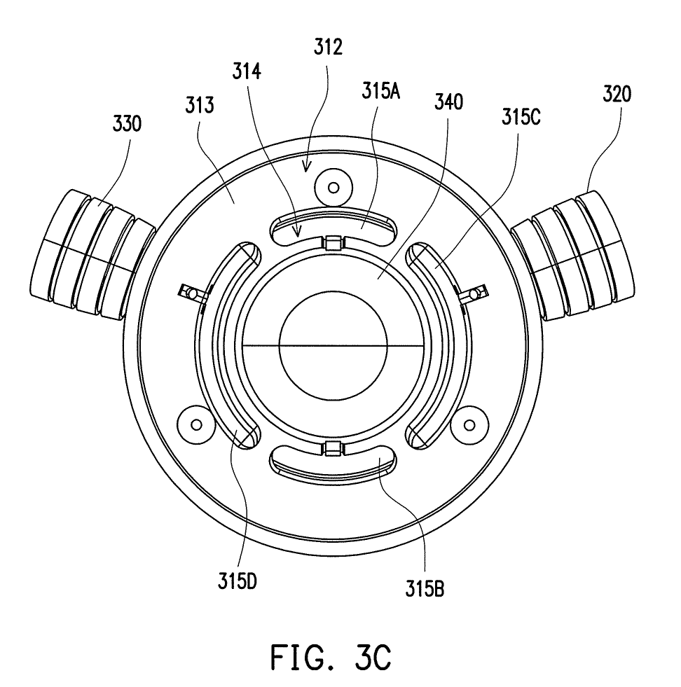

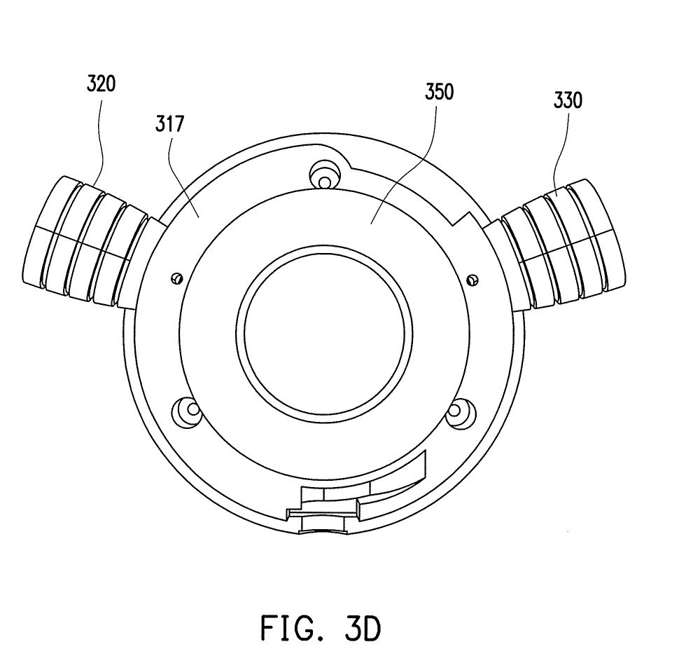

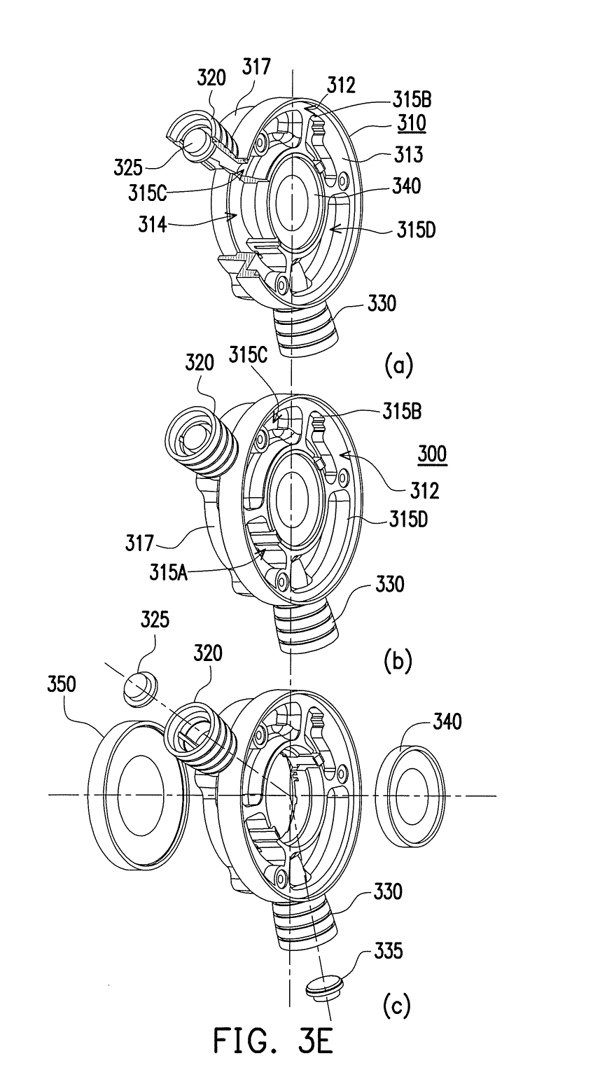

In the following, FIGS. 3A-3D respectively illustrate a front side view, rear side view, a front view, and a rear view of the multi-channel earphone according to the present embodiment.

Referring to FIGS. 3A-3D, a multi-channel earphone structure 300 comprises at least a chamber body 310, a main speaker 340 and a sub speaker 350, and chamber extension tubes 320 and 330. The chamber body 310 comprises a front mixing chamber portion 312 and a rear chamber portion 314. A main chamber supporting bar 313 is disposed between the interior of the front mixing chamber portion 312 and the rear chamber portion 314. The main chamber supporting bar 313 has a plurality of holes 315A˜315D, wherein the holes 315A and 315B are used to carry the sound field generated by the rear chamber portion 314 to the front mixing chamber portion 312 so as to mix the sound field in the front mixing chamber portion 312 and output the sound to the listener in direction 360. The main speaker 340 is disposed between the holes 315A˜315D of the main chamber supporting bar 313. The front mixing chamber portion 312 has a certain depth in the direction 360 toward the listener to form a certain space as the front mixing chamber. The depth depends on the design requirement of the multi-channel earphone structure 300.

The rear chamber portion 314 forms a space between the main chamber supporting bar 313 and a protrusion portion 317 of the chamber body 310 as the rear chamber. The sub speaker 350 is fixed on the protrusion portion 317 on the rear side of the chamber body 310.

The chamber extension tubes 320 and 330 are disposed around the chamber body 310. The sound field exits are respectively toward the holes 315C and 315D of the main chamber supporting bar 313 in the present embodiment. The dimensions of the individual chamber formed between the holes 315C and 315D of the main chamber supporting bar 313 are the consideration factor when designing the earphone main chamber structure of the present invention. Widths 319C and 319D are also the design characteristics. The sound field generated in the individual chamber formed between the holes 315C and 315D is carried to the front mixing chamber portion 312 to be mixed therein and output to the listener in the direction 360.

The dimensions of the said individual chamber may vary according to the space proportions in the chamber body 310 calculated based on the speaker characteristics. That is, the dimensions may be adjusted according to the spaces of the main chamber, the rear chamber, and the front mixing chamber. Sub speakers (as shown in the figure as sub speakers 325 and 335) may be selectively disposed on the outmost ends of the chamber extension tubes 320 and 330. Certainly, in one embodiment, the chamber extension tubes 320 and 330 may not be disposed with sub speakers but only function as extension of the main chamber space. The space structure of the chamber extension tubes 320 and 330 in the main chamber may be properly arranged according to the signal characteristics. In other words, the space in the main chamber may be adjusted so as to increase the depth and width of the sound field. Certainly, in another embodiment, the sound field exits of the chamber extension tubes 320 and 330 may be toward the rear chamber, which may also be adjusted according to design requirements.

The multi-channel earphone structure 300 comprises the chamber main body 310 and the extension sound field. The space in the main chamber is properly arranged such that the sound field space formed of the chamber extended by the chamber extension tubes 320 and 330 outside the chamber body (e.g. sub speakers 325 and 335) and front and rear speakers in the chamber (i.e. main speaker 340 and sub speaker 350) is a sound field of proper space. When a plurality of audio source signals are received in the composite chamber, the signals are mixed with the sound adjusting materials disposed in the front mixing chamber in the chamber body and form a full sound field of clear levels.

The multi-channel earphone structure 300 of the present embodiment may be used for a multi-channel audio source output by a DVD player. For example, the main speaker 340 is the front main channel speaker, the sub speaker 350 is the sub woofer speaker, the center channel speaker and the surround channel speaker may respectively be the sub speakers 325 and 335 of the chamber extension tubes 320 and 330. The abovementioned multi-channel structure 300 after being enclosed with a cover becomes a left or right side of a multi-channel earphone for use of a listener.

FIG. 3E illustrates a schematic cross-sectional view and an exploded view of the multi-channel earphone of the abovementioned embodiment of the present invention, wherein same components are denoted by same numerals. The multi-channel earphone structure 300 comprises at least a chamber body 310, a main speaker 340 and a sub speaker 350, and chamber extension tubes 320 and 330. The main chamber 310 comprises a front mixing chamber portion 312, a rear chamber portion 314, and an individual chamber portion between holes 315C and 315D formed based on space structure arrangement of the chamber extension tubes 320 and 330 according to signal characteristics. It is clear from the figure that the sound field exits of the chamber extension tubes 320 and 330 are respectively toward the space formed between the holes 315C and 315D of the main chamber supporting bar 313, which accordingly forms an individual chamber with adjustable dimensions.

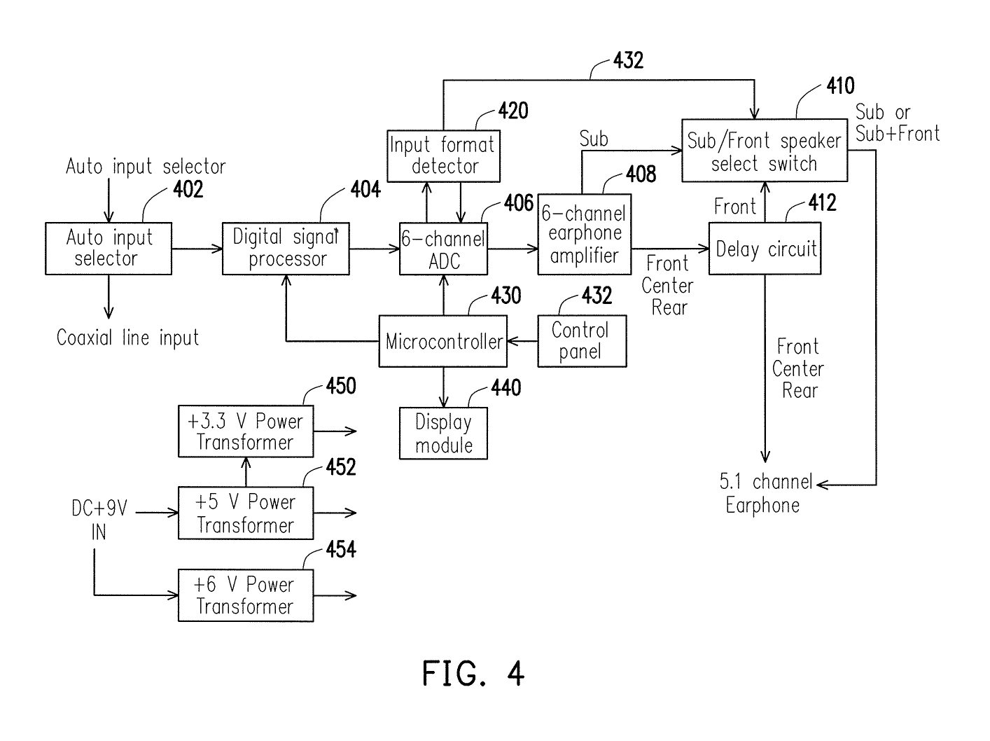

Referring to FIG. 4, FIG. 4 is a schematic diagram of the circuits of a digital decoder box capable of detecting audio source formats and according to an embodiment of the present invention.

The digital decoder box comprises an auto input selector 402, a digital signal processor 404, a 6-channel digital to analog converter 406, a 6-channel earphone amplifier 408, a sub/front speaker select switch 410, a delay circuit 412, an input format detector 420, a microcontroller 430, a control panel 432, a display module 440, and three different power supply voltages 450˜454.

First, the auto input selector 402 automatically selects an input source and outputs the signal to the digital signal processor 404. The input signal may be from an optical cable or a coaxial cable that conforms to S/PDIF or AES format. When there are signals from both sources, the optical signal has priority over the coaxial signal.

The abovementioned S/PDIF (Sony/Philips Digital Interface) format, as what the name indicates, is a format developed by the companies, Sony and Philips. There are two methods of connecting wires in the S/PDIF. The first method uses an RCA unbalanced connector and a 75 Ohm signal line and the other uses an optical cable. The S/PDIF format is the most common digital signal format in home use such as mini disk (MD) digital playing and recording, and digital surround of a DVD. The present embodiment uses an optical fiber connector of the S/PDIF format and optical fiber signal lines for output. The AES format (i.e. the AES/EBU format) uses a 75 Ohm shielded and twisted cable.

The digital signal processor 404 processes the decoding of the multi-channel sound effects, wherein the digital signal processor 404 comprises decoding software capable of processing encoded signals of Dolby Digital 5.1, Dolby Digital 2.0, Dolby Pro Logic, LPCM (stereo sound), or DTS formats.

The 6-channel digital to analog converter 406 mainly converts the digital signals decoded by the digital signal processor to analog signals. The microcontroller 430 is mainly responsible for setting the operation modes of the digital signal processor 404 and the 6-channel digital to analog converter 406 including volume control, status monitoring, etc. . . . and informing the user of messages such as the volume setting and decoding format of the decoder through the display module 440. The control panel 432 comprises selections of main volume control, center channel volume control, surround channel volume control, volume reset, and mute. The control panel 432 also outputs the selection settings to the microcontroller 430.

The 6-channel earphone amplifier 408 is responsible for amplifying the analog signals from the 6-channel digital to analog converter 406 to drive the 5.1-channel earphone. The delay circuit 412 is responsible for cutting off the impact current sent to the speakers by the amplifier at the moment of power on to protect human ears.

Voltage regulating circuits 450˜454 are used to receive an input voltage of 9V and convert the input voltage to a 3.3V voltage, a 5V voltage, and a 6V voltage respectively to provide the voltage required for the circuit operation.

The input format detector 420 is responsible for detecting whether the music format is 5.1 or 2.0 (stereo) and, based on the music format, outputting a control signal 432 to the sub/front speaker select switch 410 to control speaker arrangement for optimal sound effects. The sub/front speaker select switch 410 is used to send sub woofer signals to the left and right sub woofer speakers when the input audio source format is 5.1 channel. When the input audio source format is 2.0 channel (stereo), the left front and the right front outputs are respectively connected to the left and right sub woofer speakers to enhance the 2.0 channel sound effects, the center and rear surround channels do not have any output.

The present invention provides an earphone device comprising a digital decoder box capable of detecting audio source format and a multi-channel earphone connected to a digital audio source from a DVD player through an optical cable or a coaxial cable, for example. The digital audio source may also be from a game console or through various audio players. The earphone device provides signals of different sound field effects to the multi-channel earphone according to the content of the audio source.

Although the invention has been described with reference to a particular embodiment, thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A digital decoder box, suitable for connecting to a multi-channel earphone, the digital decoder box comprising:
a digital signal processor, for receiving a digital audio source signal and outputting a decoded signal after a decoding process being performed on the digital audio source signal;
a multi-channel digital to analog converter, connected to the digital signal processor, for receiving the decoded signal and converting the decoded signal to an analog signal;
a multi-channel earphone amplifier, connected to the multi-channel digital to analog converter, for receiving the analog signal and accordingly outputting a set of front channel signals, a set of surround channel signals, a center channel signal, and a sub woofer signal;
an input format detector, connected to the multi-channel digital to analog converter to detect the format of the decoded signal and accordingly output a control signal;
a delay circuit, used to receive the set of front channel signals, the set of surround channel signals, the center channel signal, and the sub woofer signal, perform delay processing, and then output the signals to the multi-channel earphone to prevent damage to eardrums of a user due to the impact sound when the earphone is turned on; and
a sub/front speaker select switch, connected to the input format detector and the delay circuit to receive the set of front channel signals and the sub woofer signal output from the delay circuit and switch between the front channel signals and the sub woofer signal according to the control signal, wherein when only the front channel signals but no surround channel signals or sub woofer signal are received, the sub/front speaker select switch turns off the sub woofer output and outputs the front channel signals to the left and right sub woofer speakers in the multi-channel earphone respectively to enhance the stereo sound effects.

2. The digital decoder box according to claim 1, further comprising an auto input selector used to receive two different audio sources, select one of the audio sources to be the audio source signal, and output the selected audio source signal to the digital signal processor.

3. The digital decoder box according to claim 2, wherein the audio sources with different formats are transmitted from an optical fiber line or a coaxial line.

4. The digital decoder box according to claim 3, wherein the auto input selector processes the audio source from the optical cable with a higher priority over the audio source from the coaxial cable.

5. The digital decoder box according to claim 2, further comprising an optical input port and a coaxial input port to receive the different audio sources.

6. The digital decoder box according to claim 1, wherein the digital signal processor may decode encoded signals of Dolby Digital 5.1, Dolby Digital 2.0, Dolby Pro Logic, LPCM (stereo sound), or DTS formats.

7. The digital decoder box according to claim 1, further comprising a display module to display the operating status of the digital decoder box.

8. The digital decoder box according to claim 7, wherein the operating status include the volume settings of the digital decoder box for different channels and the decoding format.

9. The digital decoder box according to claim 1, further comprising a control panel for the user to input values to adjust the control setup of the digital decoder box.

10. The digital decoder box according to claim 1, further comprising a microcontroller to control the operation modes of the digital signal processor and the multi-channel digital to analog converter.

11. The digital decoder box according to claim 10, wherein the operation modes include volume control or status monitoring.

12. The digital decoder box according to claim 10, further comprising a display module to display the operating status received from the microcontroller.

13. The digital decoder box according to claim 12, wherein the operating status include the volume settings of the digital decoder box for different channels and the decoding format.

14. The digital decoder box according to claim 10, further comprising a control panel for the user to input values to adjust the control setup status of the microcontroller.

15. An earphone device, comprising:
a digital decoder box, used to receive two different audio sources, select one of the audio sources for processing, detect the format of the audio source, and output a set of front channel signals, a set of surround channel signals, a center channel signal, and a sub woofer signal; and
a multi-channel earphone, used to receive the set of front channel signals, the set of surround channel signals, the center channel signal, and the sub woofer signal accordingly, and output sound.

16. The earphone device according to claim 15, wherein the set of front channel signals, the set of surround channel signals, the center channel signal, and the sub woofer signal are transmitted to a left front speaker and a right front speaker, a left rear speaker and a right rear speaker, a center speaker, and a sub woofer speaker of the multi-channel earphone respectively.

17. The earphone device according to claim 15, wherein when only the front channel signals but no surround channel signals or sub woofer signal are received, the set of front channel signals are integrated and output to the left and right sub woofer speakers of the multi-channel earphone respectively by the digital decoder box to enhance the stereo sound effects.

18. The earphone device according to claim 15, wherein the digital decoder box may decode encoded signals of Dolby Digital 5.1, Dolby Digital 2.0, Dolby Pro Logic, LPCM (stereo sound), or DTS formats.

19. The earphone device according to claim 15, wherein the digital decoder box further comprises a display module to display the operating status of the digital decoder box.

20. The earphone device according to claim 15, wherein the digital decoder box further comprises a control panel for the user to input values to adjust the control setup of the digital decoder box.

21. The earphone device according to claim 1, wherein the multi-channel earphone comprises:
an earphone main body, comprising a chamber body and a main chamber supporting bar, wherein the main chamber supporting bar has a plurality holes and a front mixing chamber, a main chamber, and a rear chamber are formed in the chamber body;
a main speaker and a first sub speaker, wherein the main speaker is disposed on the main chamber supporting bar, the first sub speaker is disposed on a protrusion portion of the chamber body and forms the rear chamber between the first sub speaker itself and the main chamber supporting bar, at least a pair of chamber extension tubes is disposed outside the chamber body and respectively comprises an opening toward the interior of the chamber body to form a portion of the main chamber, and a composite sound field characteristic is formed by adjusting the front mixing chamber, the main chamber, and the rear chamber in the earphone structure and used as the output of the multi-channel earphone through the space in the interior of the chamber body and the space of the chamber extension tubes.

22. The earphone device according to claim 21, wherein some of the holes of the main chamber supporting bar are used to pass the sound field formed in the rear chamber to the front mixing chamber to form the composite sound field characteristic.

23. The earphone device according to claim 21, wherein some of the holes of the main chamber supporting bar are used to pass the individual sound field formed by the pair of chamber extension tubes in the interior of the chamber body to the front mixing chamber to form the composite sound field characteristic.

24. The earphone device according to claim 21, wherein a second sub speaker and a third sub speaker are respectively disposed in the pair of chamber extension tubes and the generated sound fields respectively form individual sound fields in the interior of the chamber body.

25. The earphone device according to claim 21, wherein the main speaker is a front channel speaker of the 5.1 multi-channel audio source, the first sub speaker is a sub woofer speaker, and the second sub speaker and the third sub speaker are respectively a center channel speaker and a surround channel speaker.
